(19) United States
(12) Patent Application Publication
(10) Pub. No.: US 2008/0166163 A1
(43) Pub. Date: Jul. 10, 2008

(54) IMAGE FORMING DEVICE

(75) Inventors: Toshiharu ORUI, Kanagawa (JP); Masanori Seto, Saitama (JP); Katsuhiko Nakaie, Kanagawa (JP); Takahiko Kobayashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 11/964,968

(22) Filed: Dec. 27, 2007

(30) Foreign Application Priority Data
Jan. 5, 2007 (JP) 2007-000677

(51) Int. Cl. G03G 15/00

(52) U.S. Cl. 399/397

(57) ABSTRACT

An image forming device includes: image forming unit that controls illumination of light sources based on image data and forms electrostatic latent image, develops the electrostatic latent image to form an image, and transfers the image to a recording medium; a case that houses the image forming units; and a conveying section that conveys the recording medium while guiding the medium in a space between the case and the image forming unit.

### CROSS-REFERENCE TO RELATED APPLICATION

This application is based on and claims priority under 35 USC 119 from Japanese Patent Application No. 2007-000677 filed Jan. 5, 2007.

### BACKGROUND OF THE INVENTION

### Technical Field

The present invention relates to an image forming device.

### SUMMARY

According to an aspect of the invention, there is provided an image forming device including: an image forming unit that controls illumination of a light source based on image data and forms an electrostatic latent image, develops the electrostatic latent image to form an image, and transfers the image to a recording medium; a case that houses the image forming unit; and a conveying section that conveys the recording medium while guiding the medium in a space between the case and the image forming unit.

### BRIEF DESCRIPTION OF THE DRAWINGS

Exemplary embodiments of the present invention will be described in detail based on the following figures, wherein:

FIG. 1 is an outline configuration diagram of an image forming device according to a present exemplary embodiment;

FIG. 2 is an outline configuration diagram of an image forming device according to a first alternate example;

FIG. 3 is an outline configuration diagram of an image forming device according to a second alternate example; and

FIG. 4 is an outline configuration diagram of an image forming device according to a third alternate example.

### DETAILED DESCRIPTION

Hereafter, an example of an exemplary embodiment of the present invention will be described in detail with reference to the drawings.

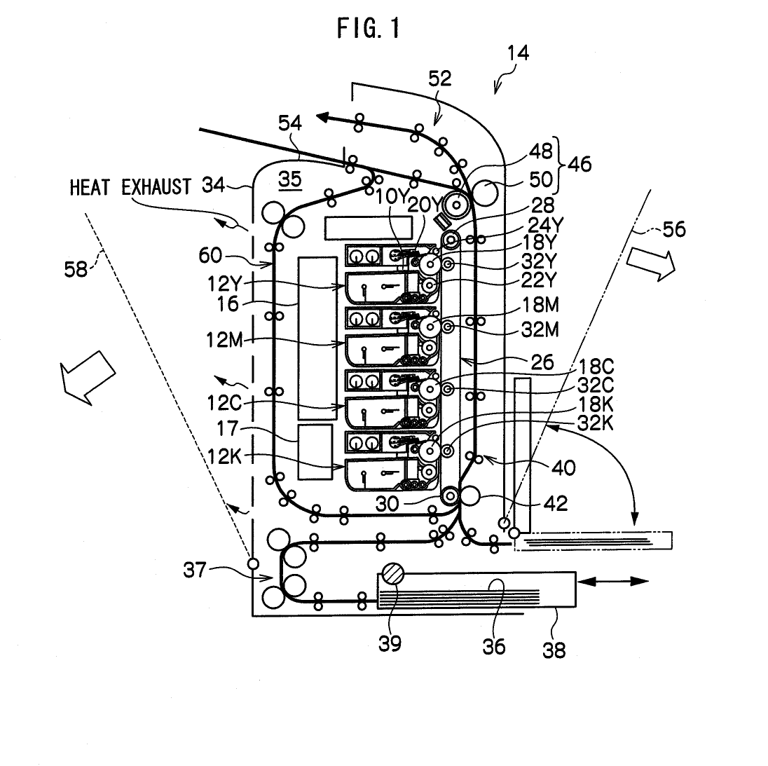

The configuration of an image forming device 14 is shown in FIG. 1, wherein four image forming units 12Y, 12M, 12C and 12K are stacked in four levels in the vertical direction and these units form images of each color of Y (yellow), M (magenta), C (cyan), and K (black). Note that the up and down directions in FIG. 1 are the vertical directions.

A controller 16 and a power source 17 are provided at the left side in FIG. 1 of the image forming units 12Y, 12M, 12C, 12K stacked in four levels. Here, the configuration components for the image forming units 12Y, 12M, 12C, 12K, the controller 16, and the power source 17 are attached in a so-called cluster of parts in the central portion of a case 34. As a result, a space 35 is provided to extend across the entire periphery between these configuration components and the case 34.

### [Configuration of Image Forming Units]

The image forming units 12Y, 12M, 12C, 12K each use an LED-array print head (LPH) 10Y as the light source (only shown for the image forming unit 12Y, for the other image forming units 12M, 12C, 12K, the structures are identical so indication by numbers has been omitted). The operation of the light source LPH is controlled by the controller 16, and lighting of LPH is controlled based on the image data of each color.

Disposed around a photoreceptor 18Y are: a charging body 20Y that uniformly charges the surface of the photoreceptor 18Y; a developing unit 22Y that supplies toner to electrostatic latent images and develops the electrostatic latent images; and a wiping unit 24Y that wipes off any residual toner on the photoreceptor 18Y after development. Note that only the above disposition is only shown for the image forming unit 12Y in the drawing. The other image forming units 12M, 12C, 12K, however, have structures that are similar to that of the image forming unit 12Y with respective components disposed around photoreceptors 18M, 18C and 18K, so explanation thereof and indication by numbers has been omitted.

Each photoreceptor 18Y, 18M, 18C, 18K in the respective image forming units 12Y, 12M, 12C, 12K has a portion thereof that protrudes in the right direction of FIG. 1 from a component that covers the image forming units 12Y, 12M, 12C, 12K, and these portions are in contact with an intermediate transfer belt 26 that is an endless belt-shaped form (i.e., the line of contact from the front of the paper surface in FIG. 1 to the inner side of the device).

The intermediate transfer belt 26 is wound around a top roller 28 provided in the vicinity of the image forming unit 12Y of the uppermost level and a bottom roller 30 provided in the vicinity of the image forming unit 12K of the lowermost step, and is made to circulate due to the driving force of a drive unit (not shown). Note that with the present exemplary embodiment, the belt circulates in the counterclockwise direction in FIG. 1.

First transfer bodies 32Y, 32M, 32C, and 32K are arranged at the inner side of the intermediate transfer belt 26 at the portions of contact between the intermediate transfer belt 26 and the photoreceptors 18Y, 18M, 18C, 18K. A preset amount of pressure is imparted to the intermediate transfer belt 26 in a state where it is nipped between the photoreceptors 18Y, 18M, 18C, 18K and the first transfer bodies 32Y, 32M, 32C, 32K.

The portions of contact between the intermediate transfer belt 26 and the photoreceptors 18Y, 18M, 18C, 18K respectively become the first transfer portions. The images of each color toner-developed on the photoreceptors 18Y, 18M, 18C, 18K are sequentially superimposed and transferred at these four places of these first transfer bodies 32Y, 32M, 32C, 32K.

More specifically, when the intermediate transfer belt 26 circulates in the counterclockwise direction of FIG. 1, a Y-color image is transferred from the photoreceptor 18Y of the image forming unit 12Y of the uppermost level and when this transfer region reaches the image forming unit 12M of the second level, an M-color image is transferred onto the same transfer region. Next, at the image forming unit 12C of the third level, a C-color image is transferred onto the same transfer region. Lastly, a K-color image is transferred onto the same transfer region at the image forming unit 12K of the lowermost step. As a result, an image with four colors (YMCK) superimposed thereon is created.

Underneath the space 35 inside the case 34, a pullout-type storage container 38 is provided in which paper 36 that is a recording medium is stacked and stored.

The topmost layers of the paper 36 are taken out from this storage container 38 one sheet at a time by a paper-retrieving mechanism 39. Next the paper 36 is sent up to the highest upstream side of the intermediate transfer belt 26 by a plurality of pairs of rollers and a paper-sending conveyer 37 formed from a plurality of pairs of guide boards, i.e., to the position where the paper 36 is inverted by the bottom roller 30.

In addition, the paper 36 is conveyed to the right side in FIG. 1 of the intermediate transfer belt 26, to along the direction of progression of the perimeter of the intermediate transfer belt 26, by a main conveying unit 40 that consists of plural pairs of rollers and plural pairs of guide boards.

The start position of the main conveying unit 40 is at the bottom roller 30 onto which the intermediate transfer belt 26 is wound. As a result, the configuration is such that the paper 36 contacts the intermediate transfer belt 26 at the region of the circular arc of contact of the bottom roller 30 with the intermediate transfer belt 26 (i.e., at a line of contact that runs from out of the page in FIG. 1 into the page).

A second transfer body 42 is arranged at the portion of contact between the bottom roller 30 and the intermediate transfer belt 26. Because of this, the intermediate transfer belt 26 and the second transfer body 42 convey the paper 36 while nipping it with a preset pressure.

The position where the pressure is imparted becomes the secondary transfer portion, and the full-color image, where the four colors were superimposed and transferred at the first transfer portions, is transferred to the paper 36 during conveyance thereof.

The paper 36 onto which the full-color image is transferred at the secondary transfer portion is guided by the main conveying unit 40, conveyed to the upper part in FIG. 1, and sent to a fixing unit 46.

A heat roller 48 and a pressing roller 50 are arranged opposite to each other in contact at the fixing unit 46. The paper 36 enters into this portion of contact and is press-processed and heat-processed. A discharge conveying section 52 that consists of plural pairs of rollers is arranged at the upper portion that is the downstream side of the paper conveying direction of the fixing unit 46.

The paper 36 on which fix-processing was completed at the fixing unit 46 has its direction switched by the discharge conveying section 52 to the left-tilting direction of FIG. 1 and is discharged to a discharge section 54 formed at the upper surface of the case 34.

### [Rotation Conveyance Path]

A circulating conveying unit 60 that guides the paper 36 is provided at the downstream side of the fixing unit 46 separately from the discharge conveying section 52. This circulating conveying unit 60 discharges the paper 36 once to the discharge section 54, but retains the rear edge portion of the paper 36.

The circulating conveying unit 60 retaining the rear edge portion of the paper 36 reverses the direction in which the paper 36 is conveyed, and pulls the paper 36 back into the case 34 once again.

The paper 36 that was pulled back in is conveyed by the circulating conveying unit, circulating conveying unit 60 underneath the space 35 of the left side of FIG. 1 of the controller 16 and the power source 17, and after being conveyed horizontally along the lower part of the space 35, the paper 36 is returned to the secondary transfer portion. Hereafter, the conveying trajectory of this type of paper 36 (i.e., the conveying route trajectory that combines the main conveying unit 40 and the circulating conveying unit 60 and that circulates around the image forming units 12Y, 12M, 12C, 12K) is referred to as an “O-type path”.

Here, it should be noted that image formation on both the front and back surfaces of the paper 36 becomes possible, i.e., on the paper 36 that is first pulled out from the storage container 38 and where an image is transferred onto a surface at the secondary transfer portion (on a first surface), and on a surface where the paper is returned with the circulating conveying unit 60 and an image is transferred at the secondary transfer portion (on a second surface).

In addition, it becomes possible to extend the time from after fixing with the fixing unit 46 until discharging at the discharge section 54 by making the paper 36 pass through the “O-type path”.

In addition, the “O-type path” is formed in the space 35 between the case 34 and the image forming units 12Y, 12M, 12C, 12K inside the case 34. Due to this, when the cover components 56, 58 and the like provided at the case 34 are opened, as shown by the dashed line and double dotted line, respectively, in FIG. 1, the paper 36 (which is in the process of passing through the conveying unit 40 or the circulating conveying unit 60) is to be found at the outside of the case 34.

The operation of the present exemplary embodiment will be explained below.

### [Image Formation Processing]

When an image formation instruction is inputted to the controller 16, image data is sent from the controller 16 to each image forming unit 12Y, 12M, 12C, 12K.

First, with each image forming unit 12Y, 12M, 12C, 12K, the surfaces around the photoreceptors 18Y, 18M, 18C, 18K are uniformly made resistant to electricity with the charging body 20Y (the same also applies for the other image forming units 12M, 12C, 12K).

Next, with each image forming unit 12Y, 12M, 12C, 12K, the illumination of the LPH 10Y is controlled based on the image data (the same also applies for the other image forming units 12M, 12C, 12K), and an electrostatic latent image is formed at the photoreceptors 18Y, 18M, 18C, 18K.

The developing unit 22Y supplies toner to the electrostatic latent image and then develops image to it (the same applies to the other image forming units 12M, 12C, 12K).

The first transfer bodies 32Y, 32M, 32C, 32K are provided at the portions of contact where each photoreceptor 18Y, 18M, 18C, 18K is in contact with the intermediate transfer belt 26. While the intermediate transfer belt 26 circulates in the counterclockwise direction in FIG. 1, a Y-color image from the photoreceptor 18Y of the image forming unit 12Y of the uppermost level is transferred. When the transfer region arrives at the image forming unit 12M of the second level, an M-color image is transferred onto the same transfer region. Next, a C-color image is transferred onto the same transfer region at the third level image forming unit 12C. Lastly, a K-color image is transferred onto the same transfer region at the image forming unit 12K of the lowermost level. As a result, images of four colors (YMCK) are layered on each other.

The toner image on the intermediate transfer belt 26 where the four colors were layered moves to the secondary transfer portion due to the intermediate transfer belt 26.

At the storage container 38, the paper 36 of the topmost layer is taken out by the paper-retrieving mechanism 39 so as to be synchronized with this movement and the paper 36 is conveyed by the paper-sending conveyer 37 to the secondary transfer portion.

At the secondary transfer portion, the intermediate transfer belt 26 and the second transfer body 42 nips the paper 36 at a preset pressure while conveying the paper 36. During conveyance of this paper 36, four colors are superimposed at the first transfer portions, and the transferred full-color image is transferred to the paper 36.

The paper 36 is sent to the fixing unit 46 while being guided by the main conveying unit 40. At the fixing unit 46, the paper 36 is press-processed and heat-processed by the pressing roller 50 and the heat roller 48 and is discharged to the discharge section 54 formed at the upper surface of the case 34 by the discharge conveying section 52.

Here, the image forming device 14 of the present exemplary embodiment is provided with a function that makes the paper 36 circulate inside the case 34, i.e., it is provided with the circulating conveying unit 60. The paper 36 is made to circulate by this circulating conveying unit 60.
(1) Form image on the front and back sides of the paper 36.
(2) Extend time until image formation is performed on the other side of the paper 36 after fixing on one side and then cooled.

When the above-described instruction (1) or (2) is sent to the image forming device 14, the paper 36 is conveyed by the main conveying unit 40 at the image forming device 14 and this paper 36 that was fixed at the fixing unit 46 is guided to a circulating conveying unit 60 that differs from the paper-sending conveyer 37.

Due to this, the paper 36 is discharged to the discharge section 54, the rear edge of the paper 36 is retained by the circulating conveying unit 60, and the rear edge side that is being retained becomes the leading end and is the conveyed in the opposite direction. At this time, the paper 36 is sent to the secondary transfer portion again by the circulating conveying unit 60.

Namely, the paper is guided from main the conveying unit 40 to the circulating conveying unit 60 and the conveying path leading again to the main conveying unit 40 becomes the “O-type path” that is an endless conveying path. Furthermore, this “O-type path” is provided in the space 35 that is between the case 34 and the central portion of the case 34 where the parts that comprise each of the image forming units 12Y, 12M, 12C, 12K, the controller 16, and the power source 17 are assembled. For this reason, the curvature radius when the paper 36, conveyed on this “O-type path”, is bent may be large.

Note that in the case of the above-described instruction (1), the paper 36 has an image transferred thereto at the second transfer portion, after which it is transferred to the main conveying unit 40. In addition, in the case of the above-described instruction (2), the paper 36 passes through as is and is transferred to the main conveying unit 40.

Due to this, the paper 36 is conveyed by the main conveying unit 40, passes through the fixing unit 46, is guided to the discharge conveying section 52, and is then discharged to the discharge section 54.

### ALTERNATE EXAMPLE 1

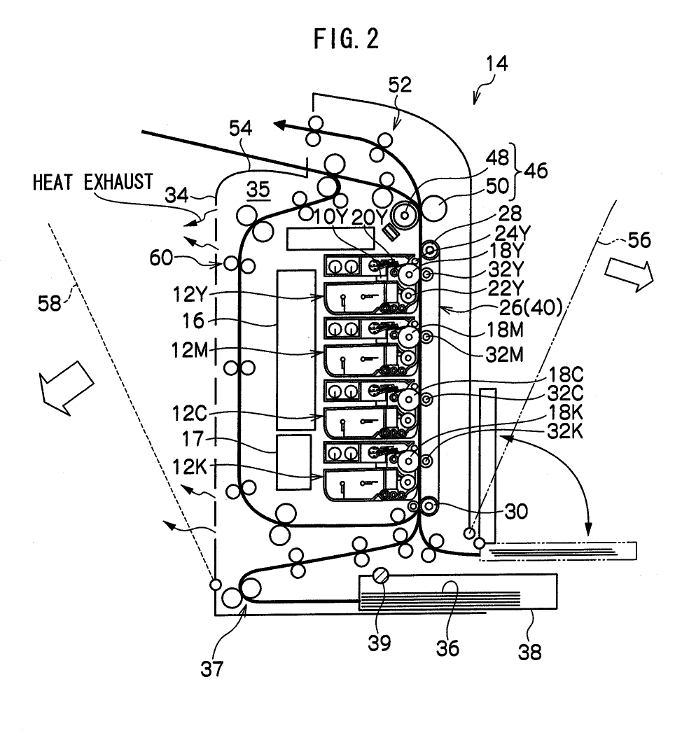

Note that with the present exemplary embodiment, the structure is such that it uses the intermediate transfer body 26, which is an endless belt-shaped body, and the images of each color transferred at the first transfer portions making are organized at the secondary transfer portion and transferred to the paper 36. Nonetheless, as shown in FIG. 2, the device can be configured so that the endless belt-shaped form is made to be a paper conveying belt (combining with the conveying unit 40) that simply guides the conveyance of the paper 36. In this case, images of each color are directly and consecutively layered on and transferred to the paper 36.

### ALTERNATE EXAMPLE 2

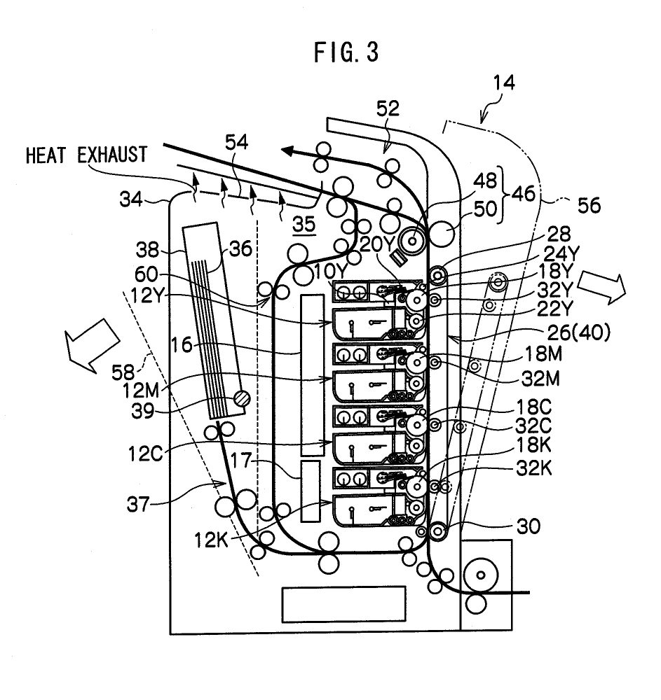

As shown in FIG. 3, Alternate Example 2 has a structure such as that of Alternate Example 1, but wherein the storage container 38 is set vertically. The available space of the image forming device 14 is used for the vertically positioned storage container 38. The image forming device one in which a laser diode is used as the light source for an optical scanning device that scans light beams in a main scanning direction, and, as in the above-described exemplary embodiment, the light source is an LPH 10Y.

In a structure with this vertically set type storage container 38 as in this Alternate Example 2, it is possible to use an intermediate transfer belt structure as an endless belt form that is separate from the conveying unit 40.

### ALTERNATE EXAMPLE 3

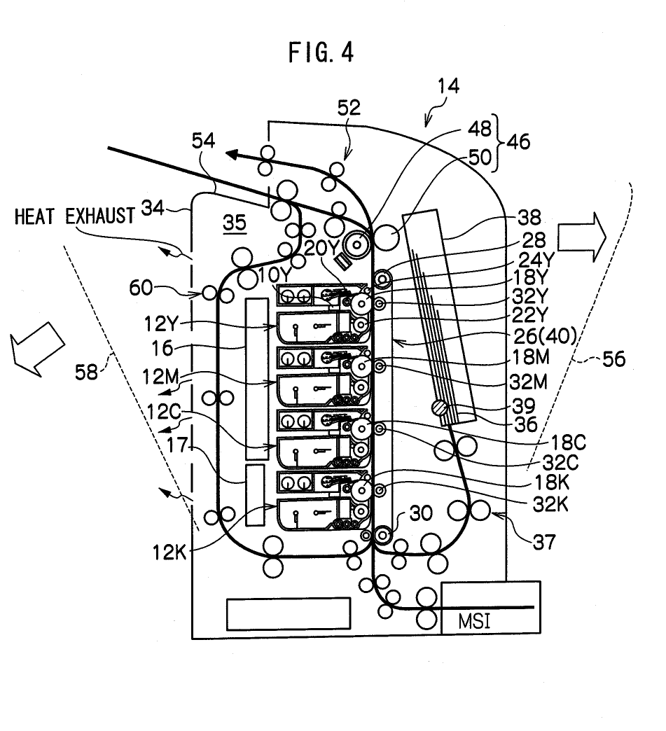

As shown in FIG. 4, Alternate Example 3 has a structure where the storage container 38 is arranged at the front side of the image forming device 14, in contrast to Alternate Example 2.

In a structure with this vertically set type storage container 38 as in this Alternate Example 3, it is possible to use an intermediate transfer belt structure as an endless belt form that is separate from the conveying unit 40.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming device, comprising:
an image forming unit that controls illumination of a light source based on image data and forms an electrostatic latent image, develops the electrostatic latent image to form an image, and transfers the image to a recording medium;
a case that houses the image forming unit; and
a conveying section that conveys the recording medium while guiding the medium in a space between the case and the image forming unit.

2. The image forming device of claim 1, further comprising:
a main conveying section that conveys the recording medium in order to form an image on the recording medium;
a discharge conveying section that discharges the recording medium after image formation from a discharge port provided in the case; and
a circulating conveying section for returning the recording medium after image formation to the upstream side of the image forming unit.

3. The image forming device of claim 1, wherein a storage container that stores the recording medium is set substantially vertically and substantially parallel to the image forming unit.

4. The image forming device of claim 2, wherein a storage container that houses the recording medium is set substantially vertically and substantially parallel to the image forming unit.

5. The image forming device of claim 3, wherein the position where the storage container is substantially vertically set is at the front surface side of the image forming device.

6. The image forming device of claim 4, wherein the position where the storage container is substantially vertically set is at the front surface side of the image forming device.

7. The image forming device of claim 3, wherein the position where the storage container is substantially vertically set is at the rear surface side of the image forming device.

8. The image forming device of claim 4, wherein the position where the storage container is substantially vertically set is at the rear surface side of the image forming device.

9. The image forming device of claim 1, wherein the storage container that stores the recording medium is set substantially horizontally in a portion underneath the image forming unit.

10. The image forming device of claim 2, wherein the storage container that stores the recording medium is set substantially horizontally in a portion underneath the image forming unit.

11. The image forming device of claim 1, further comprising:
a plurality of the image forming units are stacked at a plurality of levels along the vertical direction; and
an endless belt-shaped body repeatedly traveling through first transfer portions that are sequentially positioned opposite the transfer portion of each of the image forming units at positions where images are transferred onto the endless belt-shaped body and through a second transfer portion that is positioned so that the images that have been superimposed and transferred onto the endless belt-shaped body at the first transfer portions are transferred onto the recording medium.

12. The image forming device of claim 2, further comprising:
a plurality of the image forming units are stacked at a plurality of levels along the vertical direction; and
an endless belt-shaped body repeatedly traveling through first transfer portions that are sequentially positioned opposite the transfer portion of each of the image forming units at positions where images are transferred onto the endless belt-shaped body and through a second transfer portion that is positioned so that the images that have been superimposed and transferred onto the endless belt-shaped body at the first transfer portions are transferred onto the recording medium.

13. The image forming device of claim 1, further comprising:
a plurality of the image forming units are stacked at a plurality of levels along the vertical direction; and
an endless belt-shaped body that conveys the recording medium so that the medium sequentially faces respective transfer units of each image forming unit.

14. The image forming device of claim 2, further comprising:
a plurality of the image forming units are stacked at a plurality of levels along the vertical direction; and
an endless belt-shaped body that conveys the recording medium so that the medium sequentially faces the transfer unit of each image forming unit.
